(19) United States
(12) Patent Application Publication
(10) Pub. No.: US 2004/0236644 A1
(43) Pub. Date: Nov. 25, 2004

(54) Collaborative signal tracking

(75) Inventor: Gregory Scott Clark, Hillsborough, CA (US)

Correspondence Address: SWERNOFSKY LAW GROUP PC, P.O. BOX 390013, MOUNTAIN VIEW, CA, 94039-0013, US

(73) Assignee: e2open LLC, Redwood City, CA (US)

(21) Appl. No.: 10/666,735

(22) Filed: Sep. 19, 2003

Related U.S. Application Data
(60) Provisional application No. 60/473,091, filed on May 23, 2003.

(51) Int. Cl. G06F 17/60

(52) U.S. Cl. 705/28

(57) ABSTRACT

The invention provides a method for tracking business to business communication among trading partners in a supply chain. Trading partners utilize a central hub to coordinate and track events. Prior to sending an event to other trading partners, a trading partner obtains an event tracking number from a central hub. Trading partners receiving the event can validate its unique status and validity by observing content within the event itself and by querying the central hub for additional information. Using the invention, the disparate communication systems used by trading partners and the lack of a system for clearly identifying and tracking events, no longer exists and the possibility of confusion as to the uniqueness of any one event when compared with another with similar characteristics is eliminated.

This application claims the benefit of U. S. Provisional Application No. 60/473,091 filed May 23, 2003 (Attorney Docket No. 215.1018.01) hereby incorporated by reference.

### BACKGROUND OF THE INVENTION

1. Field of the Invention

This invention relates to tracking of events in supply chain management.

2. Related Art

Supply Chain Management (SCM) is a process-orientated approach to procuring, producing, and delivering products and services to customers. SCM has a broad scope that includes suppliers, sub-suppliers, internal operations, trade customers, retail customers, and consumers of the products and services (referred to herein as trading partners). It covers the management of material, information, and funds flows. Information passed between collaborative partners is important to the success of SCM. The quality of information, how it is perceived and used is also important to SCM operating efficiently and effectively.

Using an SCM network, a trading partner (in this case a potential purchaser of goods) can send a purchase order request to suppliers of the goods required. The request may include other details such as the date for delivery and method of payment. Unfortunately, trading partners often use differing information systems. Moreover, the flow of information from one trading partner to another can be unmonitored and unstructured in such a way that a request for goods from a trading partner can be received at another trading partner more than once. This may cause the receiving trading partner to become confused, and not know what is truly desired by the potential purchaser.

First, if more than one request for a bid is created, trading partners submit inaccurate bids. For example, XYZ Electronics decides to carpet the first floor of their two-story office complex. They request bids from trading partners (carpet suppliers/installers) for 1,000 yards of Neon Carpet Company's deep pile blue, catalog number NCC1701B. Later that day, XYZ decides they might as well carpet the second floor too, so they request bids for the same carpet type and quantity. A trading partner receiving the two bids could understandably be confused. The carpet type and quantity are identical in both requests. The payment terms, delivery date, and other order related information will probably also be identical.

In a case such as this, a trading partner may be unable to enter an accurate bid. The trading partner would not know how much underfelt, how much tackboard, how many workers, and how many delivery trucks to allow for when calculating their bid?

Second, it is possible for the same request to be received more than once by a trading partner thus leading to confusion. Often, the communication network used by trading partners in a supply chain includes multiple pathways to and from each trading partner. For example, trading partner alpha may have direct links to three other trading partners bravo, charlie, and delta. These three trading partners may have a direct link to a trading partner requesting a bid, which they each pass on to trading partner alpha. Alpha has now received what appears to be requests for three separate bids. Depending on the connectivity between the partners, the three bids could arrive on different days adding to the confusion.

Third, how does a trading partner interpret two requests for bids that are almost identical or at least similar. In the carpet example given above, suppose the second request was for Neon Carpet Company's deep pile cyan, catalog number NCC1701C. Should this be interpreted as an additional quantity or as a correction to the first request? Without more information, a trading partner cannot be sure.

Fourth, a potential purchaser may wish to treat some trading partners differently. Sending a request for bids to a number of trading partners means sending the same request to all or generating individual requests for each trading partner. The first option does not allow for individual treatment of each trading partner, and the second requires more time on the part of the potential purchaser to generate individual requests.

An important element of supply chain management is that there is effective coordination of all the links in the chain and that it be done as quickly as possible without losing any quality or customer satisfaction. Unfortunately, there are practically an unlimited number of scenarios that can create doubt and inefficiency in a supply chain.

Accordingly, it would be desirable to provide a method of communication between trading partners in a supply chain that does not suffer from the drawbacks of the prior art.

### SUMMARY OF THE INVENTION

The invention includes a method and system capable of eliminating errors in communication among trading partners in a supply chain. This is realized in an embodiment of the invention including a central hub to coordinate communication between trading partners. This removes uncertainty as to the uniqueness of any single communication event.

The central hub includes functionality to structure and monitor communication between trading partners in a supply chain. Regardless of the disparate systems and methods used by the trading partners, a layer of standardization is included in communications among them.

An event initiated by a trading partner is assigned a unique signal tracking number by the central hub. Relevant details relating to the event are associated with the signal tracking number and recorded in a database at the central hub. The unique signal tracking number is preferably incorporated into the event. Thereafter, any trading partner receiving the event can ascertain the event's signal tracking number and can compare it with other events received, thus confusion as to the unique identity of the event is refuted or confirmed.

In an aspect of the invention, metadata can be associated with the event and retained in the signal tracking database. This information can be used to further identify important attributes associated with the event. Trading partners can query the database for any additional information that may be available on an event. Such information could be relevant to the event but not actually included in it. For example, an event may refer the receiving trading partner to the metadata relating to the event retained at the hub. This allows the event to be smaller in size, and allows sensitive data to remain at a location where it can have protected access.

Access to some or all of the additional data associated with an event may be available to some trading partners and not others. This enables trading partners responding to an event to be treated differently without requiring extensive additional work by the event author.

### BRIEF DESCRIPTION OF THE DRAWINGS

FIG. 1 shows a block diagram of a system using a collaborative signal tracking number.

FIG. 2 shows a block diagram of an alternative embodiment of a system using a collaborative signal tracking number.

FIG. 3 shows a process flow diagram of a method of using a collaborative signal tracking number.

### DETAILED DESCRIPTION OF THE PREFERRED EMBODIMENT

In the following description, a preferred embodiment of the invention is described with regard to preferred process steps and data structures. Those skilled in the art would recognize after perusal of this application that embodiments of the invention can be implemented using one or more general purpose processors or special purpose processors or other circuits adapted to particular process steps and data structures described herein, and that implementation of the process steps and data structures described herein would not require undue experimentation or further invention.

Lexicography

The following terms refer or relate to aspects of the invention as described below. The descriptions of general meanings of these terms are not intended to be limiting, only illustrative.

Supply Chain—A supply chain is a chain of processes that facilitates business activities between trading partners, from the purchase of raw goods and materials for manufacturing to delivery of a finished product to an end user. Most organizations have supply chains of varying degrees, depending upon the size of the organization and the type of product manufactured. These networks obtain supplies and components, change these materials into finished products and then distribute them to the customer. The integrated supply chain is highlighted by the synchronization of the flow of information and the flow of goods between trading partners

Supply Chain Management—Supply Chain Management is a strategy where business partners jointly commit to work closely together, to bring greater value to the consumer and/or their customers for the least possible overall supply cost. This coordination includes that of order generation, order taking and order fulfillment/distribution of products, services or information. Effective management must take into account coordinating all the different pieces of this chain as quickly as possible without losing any of the quality or customer satisfaction, while still keeping costs down.

Effective supply chain management enables business to make informed decisions along the entire supply chain, from acquiring raw materials to manufacturing products to distributing finished goods to the consumer. At each link, businesses need to make the best choices about what their customers need and how they can meet those requirements at the lowest possible cost.

Event—In general, an event is a communication initiated from a trading partner within a supply chain to one or more other trading partners within the supply chain. Examples of events include; purchase orders, order confirmations, and delivery schedules.

Trading Partners—In general, trading partners include suppliers, sub-suppliers, trade customers, retail customers, and consumers of products and services, however, anyone who participates in some portion of the supply chain may be considered a trading partner.

As noted above, these descriptions of general meanings of these terms are not intended to be limiting, only illustrative. Other and further applications of the invention, including extensions of these terms and concepts, would be clear to those of ordinary skill in the art after perusing this application. These other and further applications are part of the scope and spirit of the invention, and would be clear to those of ordinary skill in the art, without further invention or undue experimentation.

System Elements

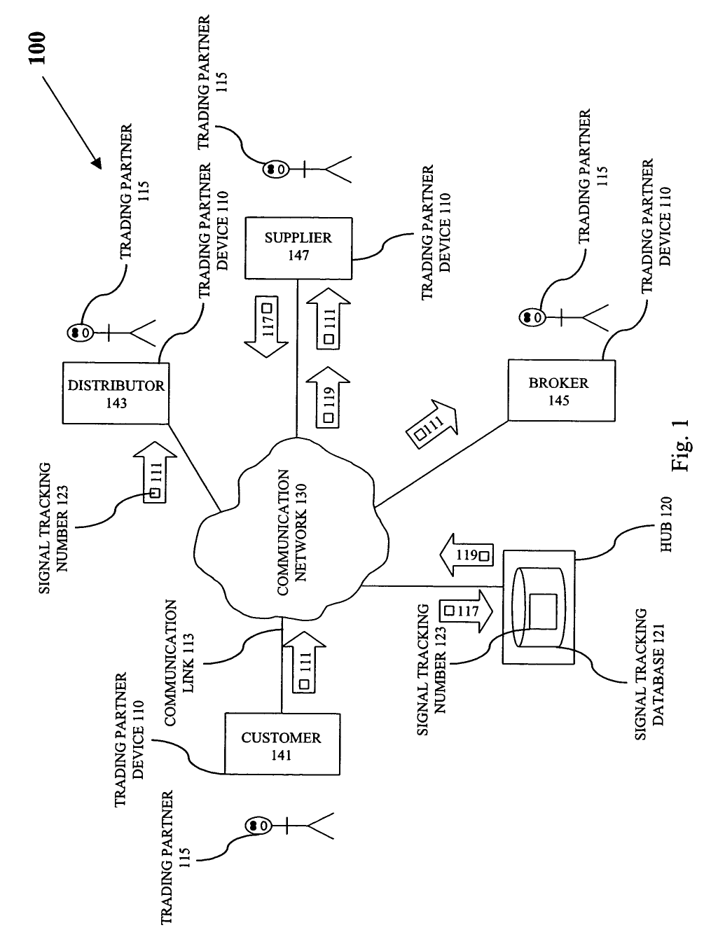

FIG. 1 shows a block diagram of a system of using a collaborative signal tracking number.

A system 100 includes a plurality of trading partner devices 110 associated with a plurality of trading partners 115, a hub 120, and a communication network 130.

An event 111 preferably includes electronic data in the form of an electronic message. The format of an event 111 is at the discretion of the sending trading partner 115 or in a format agreed to by the sender of the event 111 and the recipient trading partners 115. The format of a message can include purchase orders, order confirmations, and other supply chain management communications.

A trading partner device 110 includes a processor, a main memory, and software for executing instructions (not shown, but understood by one skilled in the art). This software preferably includes browser and other software capable of operating the trading partner device 110 consistent with the invention and further explained herein.

A trading partner 115 preferably includes a customer 141, a distributor 143, a broker 145, a supplier 147 or other type of member in the supply chain. In an alternative embodiment, a trading partner 115 may include a combination of a customer 141, a distributor 143, a broker 145, and a supplier 147 or some other type of business entity.

To illustrate an exemplary flow of an event 111 in the system 100, each trading partner device 110 in FIG. 1 has been assigned a business type of either a customer 141, distributor 143, broker 145, or supplier 147.

The hub 120 includes a signal tracking database 121 for processing, organizing and storing signal tracking numbers 123, a processor, a main memory, and software for executing instructions (not shown, but understood by one skilled in the art). This software preferably includes software for allowing the hub 120 to communicate with each trading partner device 110 and to otherwise operate the hub 120 consistent with the invention as explained further herein.

Additional data relating to an event 111 can be stored at the hub 120 when the event 111 is given a signal tracking number 123. The additional data can include other information relating to the event 111 itself or to the trading partner 115 sending the event 111. For example, a digital signature can be stored in the data at the hub 120. By using the hub 120 to store the additional data that may or may not be needed by the receiving trading partner 115, the event 111 is smaller in size allowing its transmission to be more efficient.

In an alternative embodiment, any portion of additional data can be incorporated into an event 111 and transmitted with it.

A signal tracking number 123 includes a set of data that uniquely identifies an event 111. When a signal tracking number 123 is provided by the hub 120 it is incorporated into the event 111 so it may be used to identify it.

The communication network 130 includes at least a portion of a communication network, such as a LAN, a WAN, the Internet, an intranet, an extranet, a virtual private network, a virtual switched network, or some combination thereof. In a preferred embodiment, the communication network 130 includes a packet switched network such as the Internet, as well as (in addition to or instead of) the communication networks just noted, or any other set of communication networks that enable the elements described herein to perform the functions described herein.

The preferred embodiment for the communications network 130 is a product of the affiliations of trading partners 115 and the evolution of the supply chains in which they participate. As previously stated in the preferred embodiment for this element, the communications network 130 may include many different types of computerized networks. Generally, the more complex the communications network 130, the greater the need for the invention.

A communication link 113 operates to couple each trading partner device 110 and the hub 120 to the communications network 130. When a trading partner device 110 is connected to more than one communication network 130, more than one other trading partner device 110, or some combination thereof, more than one communication link 113 may be used.

A query 117 includes a request to the hub 120 to provide information regarding an event 111 identified by its signal tracking number 123.

A response 119 includes substantially detailed information related to an event 111. The author of an event 111 provides the information contained in a response 119. Any additional information is stored at the hub 120. The format of additional information relating to an event can be controlled by the hub 120 or left entirely at the discretion of the authoring trading partner 115.

Alternative Embodiment of a System 100

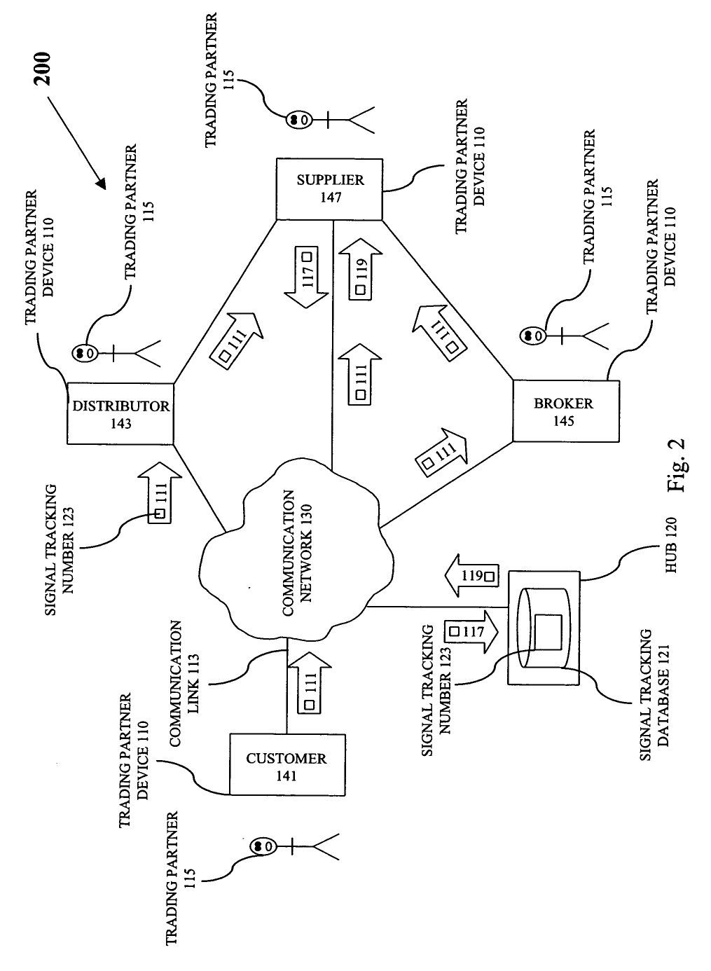

FIG. 2 shows a block diagram of an alternative embodiment of a system of using a collaborative signal tracking number.

This embodiment illustrates multiple connectivity between trading partners. The trading partner device 110 (supplier 147) is coupled to the communication network 130 and to two other trading partner devices 110 (the distributor 143 and the broker 145).

This alternative embodiment illustrates how an event 111 can be received by a trading partner device 110 more than once. In this particular example, at least three identical events 111 can be received by the trading partner device 110 operated by the supplier 147. First an event 111 can be received from the customer 141 via the communication network 130. Second, an event 111 can be received from the customer 141 via the communication network 130 through the distributor 143. Third, event 111 can be received from the customer 141 via the communication network 130 through the broker 143. This alternative embodiment is exemplary and not intended to be limiting. The number of trading partner devices 110 and lines of connectivity are practically without limit.

Method of Operation

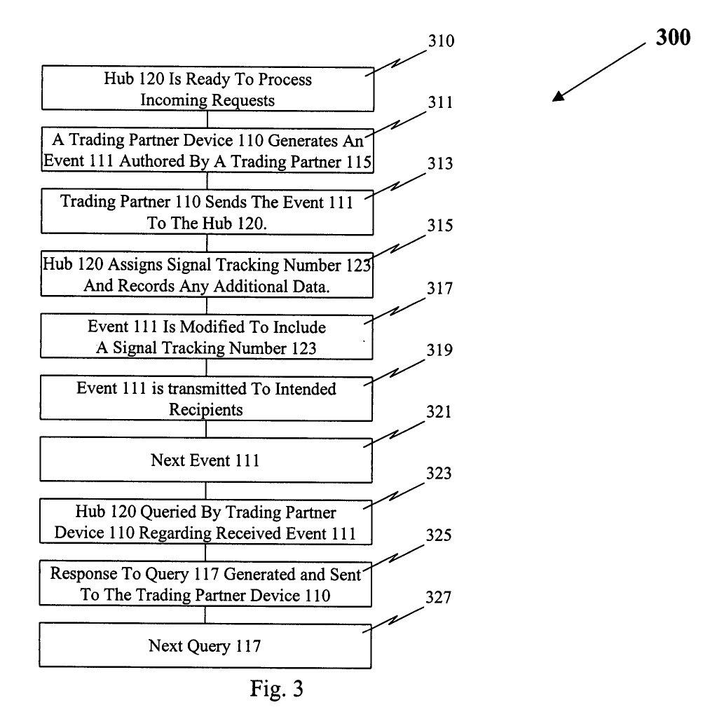

FIG. 3 shows a process flow diagram of a method of using a collaborative signal tracking number. The method 300 is performed by the system 100. Although the method 300 is described serially, the steps of the method 300 can be performed by separate elements in conjunction or in parallel, whether asynchronously, in a pipelined manner, or otherwise. There is no particular requirement that the method 300 be performed in the same order in which this description lists the steps, except were so indicated.

At a flow point 310, the hub 120 is ready to process incoming requests for signal tracking numbers 123 and to respond to a query 117.

At a step 311, a trading partner 115 authors an event 111, which is generated by the trading partner device 110. The authoring trading partner 115 identifies a list of recipients for the event 111. The event 111 may be of any of the types previously mentioned.

At a step 313, the trading partner device 110 sends the event to the hub 120 for processing. In an alternative embodiment, the trading partner device 110 sends a request for a signal tracking number 123 to the hub 120.

At a step 315, the hub 120 assigns a unique signal tracking number 123 to the event 111 and records the assignment in the signal tracking database 121. Additional information relating to the Event 111 can be recorded at the hub 120 for future reference. The additional information is linked to the event 111 by its signal tracking number 123.

At a step 317, The event 111 is modified to include the signal tracking number 123. In an alternative embodiment, the signal tracking number 123 is transmitted to the trading partner device 110 where the event 111 is being authored. At that location the event 111 is modified to include the signal tracking number 123.

At a step 319, the event 111 is transmitted to the list of recipients identified by the authoring trading partner 115.

At a flow point 321, the process may be repeated starting at step 310 to enable additional events 111 to be generated and assigned a signal tracking number 123.

At a step 323, a query 117 is sent from a trading partner device 110 to the hub 120. Initiating a query 117 allows the trading partner 115 who received the event 111 to obtain additional information regarding the event 111. Upon receipt of an event 111, a query 117 can be sent manually or automatically by the receiving trading partner device 110 to establish the status of the event 111 and obtain any additional information available.

Although the unique identity of events 111 can be gleaned by comparing the assigned signal tracking numbers 123, additional information may be necessary to clarify similar appearing events 111 that differ only by the signal tracking numbers 123 and to ascertain the exact intent of the sending trading partner 115. For example, a trading partner may issue a first purchase order for 100 gallons of purple paint and then a second purchase order for the exact same product and quantity. A trading partner 115 may wonder whether one of the purchase orders is an error or a true additional request. The additional data stored at the hub 120 can be used to clarify these common issues.

At a step 325, a response 119 is sent by the hub 120 to the trading partner device 110 that initiated the query 117. The signal tracking number 123 in the query 117 is matched with the appropriate record in the signal tracking database 121. Any additional data can be included in the response 119 as requested. If the event 111 is found to be a duplicate, the trading partner device 110 can be configured to automatically discard it or otherwise process it as a duplicate event 111.

At a flow point 327, the process may be repeated starting at step 323 to allow additional events 111 to be queried.

Generality of the Invention

The invention has applicability and generality to other aspects of business to business communication and collaboration between business entities.

Alternative Embodiments

Although preferred embodiments are disclosed herein, many variations are possible which remain within the concept, scope, and spirit of the invention, and these variations would become clear to those skilled in the art after perusal of this application.

1. A method for doing business including
generating a supply chain communication event at a sender for delivery to a set of recipients, said set of recipients including trading partners in a supply chain;
processing said event at a central hub, said processing including modifying said event to be uniquely identifiable;
delivering said event in its modified form to said set of recipients; and
querying said central hub responsive to receipt of said event.

2. The method of claim 1, wherein said processing includes
sending said event to said hub, said hub including a database for storing a plurality of unique identifiers associated with a plurality of said events and sets of data descriptive of said events;
appending a unique identifier to said event at said hub;
storing a set of data at said hub, said data descriptive of said event and indexed to said unique identifier; and
delivering said event to a set of recipients.

3. The method of claim 2, wherein said hub is located at a location logically remote to said generating;

4. The method of claim 2, wherein said appending includes recording the step of said appending in said database.

5. The method of claim 2, wherein said storing includes saving a set of said data descriptive of said event in said database further including additional data supplied by said sender.

6. The method of claim 2, wherein said delivering includes sending said event in its modified form to said set of recipients.

7. The method of claim 1, wherein said querying includes
sending a query to said hub from at least one of said set of recipients, said query requesting additional information responsive to receipt of at least one said event.
generating a response to said query; and
delivering said response to at least one of said set of recipients.

8. The method of claim 7, wherein said sending is (1) performed manually at the request of one of said set of recipients, or (2) performed automatically responsive to receipt of a said event.

9. The method of claim 7, wherein said sending includes identifying a said event for which additional information is requested, said identifying including matching a unique identifier associated with said event with a record of said unique identifier in a database at said hub.

10. The method of claim 7, wherein said generating includes creating an electronic message of additional information from said database associated with said event identified by said unique identifier.

11. An apparatus including
means for generating a supply chain communication event at a sender for delivery to a set of recipients, said set of recipients including trading partners in a supply chain;
means for processing said event at a central hub, said means for processing including means for modifying said event to be uniquely identifiable
means for delivering said event in its modified form to said set of recipients; and
means for querying said central hub responsive to receipt of said event.

12. The method of claim 11, wherein said means for processing includes
means for sending said event to said hub, said hub including a data-base for storing a plurality of unique identifiers associated with a plurality of said events and sets of data descriptive of said events;
means for appending a unique identifier to said event at said hub;
means for storing a set of data at said hub, said data descriptive of said event and indexed to said identifier; and
means for delivering said event to a set of recipients

13. The method of claim 12, wherein said hub is located at a location logically remote to said generating;

14. The method of claim 12, wherein said means for appending includes means for recording the step of said appending in said database.

15. The method of claim 12, wherein said means for storing includes means for saving a set of said data descriptive of said event in said database further including additional data supplied by the sender.

16. The method of claim 12, wherein said means for delivering includes means for sending said event in its modified form to said set of recipients.

17. The method of claim 11, wherein said means for querying includes
means for sending a query to said hub from at least one of said set of recipients, said query requesting additional information responsive to receipt of at least one said event.
means for generating a response to said query; and
means for delivering said response to at least one of said set of recipients.

18. The method of claim 17, wherein said means for sending said query is (1) performed manually at the request of a recipient, or (2) performed automatically responsive to receipt of a said event.

19. The method of claim 17, wherein said means for sending includes means for identifying a said event for which additional information is requested, said means for identifying including means for matching a unique identifier associated with said event with a record of said unique identifier in a database at said hub.

20. The method of claim 17, wherein said means for generating includes means for creating an electronic message of additional information from said database associated with said event indicated by said unique identifier.

21. Computer readable media including written thereon instructions readable by a computer to perform the steps of
generating a supply chain communication event for delivery to a set of recipients, said set of recipients including trading partners in a supply chain;
receiving said event at a central hub;
modifying said event to include a unique identifier, said identifier stored with additional information descriptive of said event in a database at said hub;
delivering said event in its modified form to said set of recipients;
querying said event for said information descriptive of said event, said querying including matching said unique identifier included in said event with said identifier stored in said database; and
responding to said querying, said responding including delivery of information descriptive of said event.
